(19) United States
(12) Patent Application Publication
(10) Pub. No.: US 2006/0053247 A1
(43) Pub. Date: Mar. 9, 2006

(54) Incremental erasing of flash memory to improve system performance

(76) Inventors: Hugo Cheung, Tucson, AZ (US); Rituparna Ghosh, Tucson, AZ (US)

Correspondence Address: TEXAS INSTRUMENTS INCORPORATED, P O BOX 655474, M/S 3999, DALLAS, TX, 75265, US

(21) Appl. No.: 10/935,780

(22) Filed: Sep. 8, 2004

(51) Int. Cl. G06F 12/00

(52) U.S. Cl. 711/103

(57) ABSTRACT

A method and system for erasing a page in a flash memory system including a CPU (11), a flash memory (12) including an array of flash memory cells (1), a flash memory controller (12A) coupled to the flash memory (12) and also coupled by a memory bus (19) to the CPU (11) operate the CPU (11) in response to a page erase signal produced during execution by the CPU (11) of a user application program to erase a page of the flash memory by causing the CPU (11) to generate a first incremental erase interval of substantially shorter duration than a total erase time required to erase the flash memory, cause the memory controller (12A) to take control of the memory bus and apply erase signals to the flash memory cells of the page during the first incremental erase interval, and cause the CPU (11) to take control of the memory bus (19) after the first incremental erase interval and execute a pending task. This procedure is repeated for a plurality of additional incremental erase intervals, respectively, the cumulative amount of time of all of the incremental erase intervals being sufficient to result in erasure of the page with a determined retention time.

### BACKGROUND OF THE INVENTION

The present invention relates generally to flash memories, and more particularly to a way of reducing system delay in responding to interrupt service routine (ISR) requests and other background tasks during flash memory erase operations.

FIG. 1 shows a section view of a typical flash memory cell, which includes a floating gate MOS structure. Referring to FIG. 1, flash memory cell 1 is formed on a P-type substrate 2 having an N-type source region 3 and an N-type drain region 4 formed in its upper surface. Source region is connected to a conductor used in the erase process. Drain region 4 is connected to a bit line conductor. A channel region 9 within which a N-type channel region can be induced by a “1” voltage level stored on a floating gate 6 is disposed between the edges of source region 3 and drain region 4. A thin gate oxide layer 7 extends over channel region 9. A “floating” gate 6 is a doped, conductive polycrystalline silicon layer formed on floating gate insulator 7 over channel region 9. An upper gate oxide layer 8 is disposed on the upper surface of floating gate 6. A control gate conductor 26 is formed on the upper surface of gate oxide layer 8. Control gate 26 is connected to a word line conductor.

Writing of information onto floating gate 6 is typically accomplished by the well-known technique of hot electron injection. Erasing of information from floating gate 6 is typically accomplished by Fowler-Nordheim (FN) tunneling, described in “An Enhanced Erase Mechanism during the Channel Fowler-Nordheim Tunneling in Flash EPROM Memory Devices”, IEEE Electron Device Letters, volume 20, No. 3, March 1999, page 140.

Flash memory can be read as long as it is being powered and is not being written into, and it retains data even when the power is turned off, i.e., is non-volatile. Writing data into a section or page of a flash memory can be performed when the power is on, but only if the section or page of the flash memory has been erased first. A write operation to a flash memory cell can only change, i.e., program, a “1” to a “0”, but a write operation can not “erase” a flash memory bit, i.e., write a “0” back to a “1”. In order to change a flash memory bit from “0” to “1”, a time-consuming erasure process, usually referred to as a “page erase”, must occur.

The page erase command takes much longer to perform than the write process. For manufacturing reasons, flash memory chips are not made with the capability of erasing individual bits or bytes, and are constructed so that only large sections, e.g., pages, of flash memory (usually 64 bytes or more) can be erased at a time.

As indicated above, flash memory transistor cell 1 stores its state voltage on a floating gate 6 which is isolated using thin gate oxide layers 7 and 8 above and below floating gate 6, as shown in FIG. 1. Floating gate 6 can store extra electrons which can be moved into or out of floating gate 6, and this is accomplished by “writing” or “erasing” the state voltage stored on floating gate 6 (by the process of the above mentioned Fowler-Nordheim tunneling). A sufficient number of additional electrons in floating gate 6 constitutes a stored logic “1” state in the flash memory transistor cell. Floating gate 6 is capacitively coupled to control gate 26, by means of which the value of the state voltage stored on floating gate can 6 be controlled.

Erasing flash memory cell 1 to a logical “1” state is achieved by applying a sufficient erase voltage between the source 3 of the flash memory cell transistor and its control gate 26. Source 3 of the flash memory cell transistor is switched to a voltage less than 0 volts while control gate 26 is kept at a voltage greater than 0 volts and drain 4 is open. This causes the electrons to tunnel from source 3 and substrate 2 to floating gate 6 to establish a “0” state voltage on floating gate 6.

After a section or page of the flash memory has been erased, a logical “0” can be written into a flash memory cell 1 in the erased page or section by applying the opposite voltage to that mentioned above for erasing across drain 4 and control gate 6 of the flash memory cell. This causes electrons to tunnel back from floating gate 6 to substrate 2 and drain 4 of the flash memory cell.

Thus, individual flash memory bits can be “written” or changed from “1” to “0” states, but flash memory bits can not be individually erased, i.e. changed from “0” to “1” states, and instead must be erased to “1” states a full page at a time. Flash memory offers electrical erasability and programmability at a lower cost than EEPROM (electrically erasable programmable read only memory). Note that an EEPROM allows both programming (i.e., writing) and erasing on a byte level or word level. In contrast to EEPROM, however, flash memory only allows erasing to be performed on a page level, although it allows programming or writing on a byte or word level. Selection of a page, rather than a single flash memory location, is required to accomplish erasure a page of a flash memory. (Hence the name “flash” memory.) This allows the amount of chip area required for implementing the page selection circuitry to effectuate erasing of an entire page of flash memory in a single erase operation to be greatly reduced compared to the amount of chip area required for implementing circuitry for erasing a comparable EEPROM.

Thus, writing new information into a flash memory is performed only after it has been erased by either an initial mass erase operation or by subsequent page erase operations. The present invention relates only to page erase operations. The mass erase operation usually occurs only once, during manufacturing of the flash memory. The hot electron injection used to write new data into the flash memory cell occurs after a conductive channel has been induced in channel region 9 at the interface between P-type silicon substrate 2 and gate dielectric 7 in response to a stored “1” on floating gate 6, while a suitable high current level is flowing through the induced channel. The high channel current causes the FT tunneling of hot (i.e., high-energy) electrons across gate insulator 7, causing floating gate 6 to be charged to a suitable voltage level that represents a “1”.

Taiwan Semiconductor Corporation (TSMC) markets a proprietary flash memory “core” system suitable for embedding in integrated circuit chips. The embedded proprietary flash memory core systems include an array of the flash memory cells shown in FIG. 1 and associated address decode circuitry, sense amplifiers, and high-voltage charge pump circuitry. The charge pump circuitry includes high-voltage generators which provide the high voltage levels needed for writing and erasing flash memory cells. (The low value of erase voltage is about 2.7 volts and the high value of erase voltage is about 15 volts.) The flash memory cells are arranged in rows and columns with associated decode address circuitry and sense amplifiers. Each page can be organized, for example, as 2 rows of 64 bytes each, i.e., 128 bytes, although this organization can be varied. The page erasing is accomplished by activating an entire page and erasing each memory cell of that page, two rows at a time, for a sufficiently long time.

The prior art, such as the assignee's MSC 1210 microsystem chip, includes a complete microsystem including a single-partition embedded TSMC flash memory array, flash memory controller, and associated circuitry, wherein a flash memory page erase operation, once started, must be completed before the CPU can access the page being erased. The assignee's MSC 1210 microsystem chip is described in the publication “MSC 1210 Precision Analog-to-Digital Converter (ADC) with 8051 Microcontroller and Flash Memory”, SBAS203C-March 2002-revised May 2004”, which is incorporated herein by reference.

In a typical system, execution of the user application program is completely blocked for 4 or 11 milliseconds (usually 4 milliseconds for a “commercial” product or 11 milliseconds for an “industrial” product), and no peripheral devices can be serviced by the CPU. The un-interrupted 4 or 11 millisecond erase time and resulting CPU idle time is unacceptable in many applications.

The prior art technique for performing a flash memory page erase function is illustrated in the timing diagram of FIG. 2. Referring to FIG. 2, normal CPU operation is indicated during time interval 20A, after which a page erase operation is desired. Time interval 20B indicates an un-interrupted duration of approximately 4 or 11 milliseconds, during which no access by the CPU to the flash memory is permitted. This means the CPU cannot service any interrupt request or perform any other background task until the end of page erase interval 20B, i.e., until the beginning of interval 20C. This very long wait time may be burdensome or unacceptable to the user.

A typical flash memory access controller includes hard wired internal timing circuitry that includes a delay element which would determine the duration of a flash memory access. The time interval allowed for a conventional complete flash memory page erase operation is usually determined by the values of an internal resistor and capacitor, which determine a fixed internal flash memory access time. That technique does not permit segmenting the total erase time provided by the subsequently described present invention. Furthermore, the foregoing prior art technique causes the time interval allowed for a complete flash memory page erase operation to be very process-dependent.

Important flash memory parameters include flash memory retention time and endurance. The flash memory retention time indicates how long the flash memory can hold information at room temperature, which is typically specified as 100 years. The retention time is verified by stressing the flash memory at higher than normal temperatures and higher than normal voltages to, in effect, “speed up” the aging process, and then determining how long data can be stored. That amount of time then is extrapolated to determine the flash memory retention time at room temperature.

The flash memory “endurance” parameter indicates how many read/erase cycles (typically at least 100,000 minimum, and more typically, approximately a million) can be safely endured by each flash memory cell at room temperature. The endurance specification for the above mentioned proprietary TSMC embedded flash memory systems is at least 20,000 read/erase cycles at room temperature.

The above mentioned 4 millisecond or 11 millisecond amount of time required to erase a page of flash memory cells is a very long amount of time relative to the amount of time required for execution of an interrupt service routine request in a typical microsystem, which may be roughly 10 to 100 microseconds, depending on the clock frequency of the system. The wait time required for a flash memory page erase operation represents a very long, often unacceptably long, system delay before an interrupt service routine can be executed or before execution of an application program can continue. Consequently, the system response time is very long because typical tasks such as communication via a UART (universal asynchronous receiver/transmitter), executing the real-time operating system, data acquisition via an analog-to-digital converter, etc. cannot be performed by the CPU until the long page erase operation has been completed.

A major problem of prior systems including single-partition flash memory is the above mentioned very slow system response to an interrupt service routine request. The system CPU usually must access the flash memory in order to execute an interrupt service routine or an application program, because the flash memory usually stores at least some of the information required for execution of the interrupt service routine or application program. Consequently, the information required for execution of the application program usually is not available to the system CPU during any flash memory page erase operation.

Some prior art systems, such as certain systems by Phillips Corp. and Infineon Corp., attempt to solve the foregoing problems caused by long flash memory erase times by partitioning the flash memory into two partitions or blocks, and by providing flash memory controller circuitry that allows the CPU to access one partition of the flash memory while the other is undergoing a page erase operation. This improves overall system performance somewhat, since if there is only one block of flash memory cells, then the CPU is not allowed to access to any part of the flash memory and can only stand by and poll the flash memory to determine when the entire page erase operation is complete, and only then can the CPU respond to an interrupt service routine request or continue executing a user application.

As indicated above, the prior approach of providing two flash memory partitions requires the flash memory controller, which controls all of the flash memory access (including read operations, write operations, and erase operations), to be much more complicated than if the entire flash memory is organized as a single partition. Specifically, about 35 percent more silicon is required in order to implement a flash memory system including two partitions of flash memory cells and associated flash memory controller, because more sense amplifiers and address decoders are be required than would be required for a “single partition” flash memory system. Furthermore, the required charge pump circuitry would be much larger for a two-partition flash memory system.

Thus, there is an unmet need for an integrated circuit including a flash memory system which avoids long system delays prior to responding to interrupt service routine requests that occur during flash memory page erase operations.

There is another unmet need for an integrated circuit system including a flash memory system which reduces the time required for response to an interrupt service routine request.

There is another unmet need for an integrated circuit including a flash memory system which avoids long system delays in responding to interrupt service routine requests that occur during flash memory page erase operations, without unacceptably diminishing important flash memory parameters such as flash memory retention time and endurance.

There is another unmet need for an integrated circuit including a flash memory system which avoids long system delays in responding to interrupt service routine requests that occur during flash memory page erase operations, without unacceptably diminishing important flash memory parameters such as flash memory write time, retention time, and endurance, and which also avoids the need for substantial additional hardware and software.

There is another unmet need for a flash memory system in which page erase times are substantially independent of the manufacturing process utilized to fabricate the flash memory system.

### SUMMARY OF THE INVENTION

It is an object of the invention to reduce the response time to an interrupt service routine request in a system including flash memory.

It is an object of the invention to provide an integrated circuit system including flash memory which avoids long system delay or wait times during a page erase operation of the flash memory.

It is another object of the invention to provide an integrated circuit including a flash memory system which avoids long system delays in responding to interrupt service routine requests that occur during flash memory page erase operations, without unacceptably diminishing important flash memory parameters such as flash memory retention time and endurance.

It is another object of the invention to provide an integrated circuit including a flash memory system which avoids long system delays in responding to interrupt service routine requests that occur during flash memory page erase operations, without unacceptably diminishing important flash memory parameters such as flash memory write time, retention time, and endurance, and which also avoids the need for substantial additional hardware and software.

It is another object of the invention to provide a segmented flash memory page erase system providing a substantial number of incremental page erase intervals without substantially increasing the size of the semiconductor chip.

It is another object of the invention to provide a segmented flash memory page erase system providing a substantial number of incremental page erase intervals without unacceptably diminishing certain flash memory performance parameters, including flash memory endurance specifications and flash memory retention specifications.

It is another object of the invention to provide a flash memory system in which page erase times are substantially independent of the manufacturing process utilized to fabricate the flash memory system.

Is another object of the invention to provide a flash memory system which substantially reduces power consumption in sense amplifiers of the flash memory cell array.

Briefly described, and in accordance with one embodiment, the present invention provides a method of erasing a page in a flash memory system including a CPU (11), a flash memory (12) including an array of flash memory cells (1), a flash memory controller (12A) coupled to the flash memory (12) and also coupled by a memory bus (19) to the CPU (11). The method includes operating the CPU (11) in response to a page erase signal produced during execution by the CPU (11) of a user application program to erase a page of the flash memory to cause the CPU (11) to perform the steps of generating a first incremental page erase interval of substantially shorter duration than a total erase time required to erase the flash memory, causing the memory controller (12A) to take control of the memory bus and apply erase signals to selected flash memory cells during the first incremental page erase interval, causing the CPU (11) to take control of the memory bus (19) after the first incremental page erase interval and execute a pending task, and repeating the same process for a plurality of additional incremental page erase intervals, respectively. The cumulative amount of time of all of the incremental page erase intervals is sufficient to result in erasure of the page of the flash memory (12) with at least a specified flash memory retention time. In the described embodiment, an incremental page erase interval program is stored in a memory (18) coupled to the memory bus (19), and the CPU is operated to execute the incremental page erase interval program. In the described embodiment, the cumulative amount of time of all of the incremental erase intervals slightly exceeds a specified time interval for accomplishing a complete page erase operation on the flash memory. The incremental page erase intervals can be of equal duration. The CPU (11) initializes a register by writing a value which determines the duration of the incremental page erase time intervals. In the described embodiment, the flash memory system is internal to an integrated microsystem including a plurality of peripheral devices, wherein one of the peripheral devices includes a delta sigma analog-to-digital-converter.

### BRIEF DESCRIPTION OF THE DRAWINGS

FIG. 1 is a section view diagram of the prior art flash memory cell.

FIG. 2 is a timing diagram illustrating system operation of a prior art microsystem including an embedded flash memory system during a flash memory page erase operation.

FIG. 3 is a block diagram of a typical microsystem implemented on a single integrated circuit chip and including various system components such as a CPU, a memory system including a flash memory and a flash memory controller, an analog to digital converter, and a digital to analog converter.

FIG. 4 is a flow chart of an algorithm executed by the CPU in accordance with the present invention to segment flash memory page erase operations to allow faster system response to interrupt service routine requests by the CPU.

FIG. 5 is a timing diagram useful in describing the operation of the microsystem of FIG. 3 to segment flash memory page erase operations in accordance with the flow chart of FIG. 4 to allow faster system response to interrupt service routine requests by the CPU.

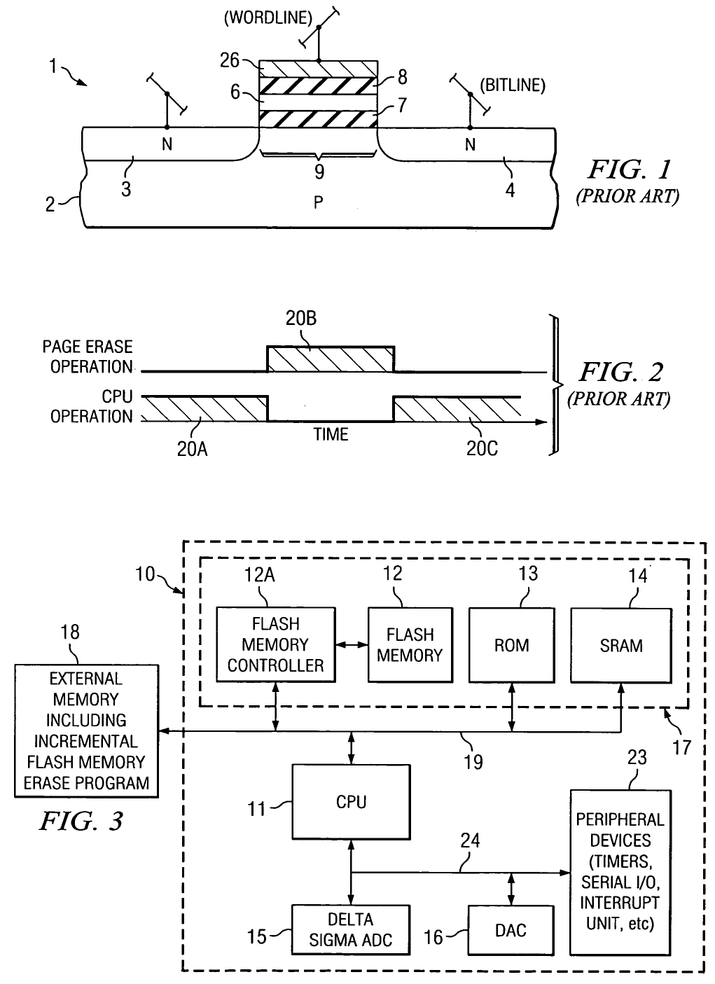

### DETAILED DESCRIPTION OF THE PREFERRED EMBODIMENTS

FIG. 3 is a simplified of diagram of a 24-bit delta sigma ADC microsystem 10 including a microcontroller which includes a CPU, a flash memory cell array, and a flash memory controller. Microsystem 10 also includes an ADC, a DAC, and a number of peripheral devices. Microsystem 10 stores and executes an algorithm which segments flash memory page erase operations to allow faster system response by the CPU to interrupt service routine requests. Microsystem 10 can be the assignee's MSC 1210 microsystem chip.

Referring to FIG. 3, microsystem 10 is implemented on a single integrated circuit chip, and includes a CPU (central processing unit) 11 coupled to a memory subsystem 17 which includes a static random access memory (SRAM) 14, a read-only memory (ROM) 13, and a TSMC flash memory system including a flash memory array 12 and a flash memory controller 12A, all accessible by CPU 11 via a memory bus 19. The TSMC flash memory system 12,12A can be the TSMC SFA0008_{—}08A8I product which is commercially available as an “embeddable” system provided by Taiwan Semiconductor Corporation (TSMC).

Memory bus 19 can be coupled to an external memory 18 which includes an “incremental flash memory erase program” according to the present invention. Alternatively, the incremental flash memory erase program can be included in flash memory 12, ROM 13 and/or SRAM 14. CPU 11 is coupled by an SFR (Special Function Register) bus 24 to various peripheral devices in block 23, such as hardware timers, serial input/output circuitry, an interrupt unit, etc., as indicated in block 23. CPU 11 also is coupled by SFR bus 24 to an ADC (analog-to-digital converter) 15 and a DAC (digital-to-analog converter) 16. The portion of microsystem 10 including CPU 11, peripheral devices 23, and memory system 17 may constitute a conventional microcontroller.

CPU 11 accesses the memory system 17 including flash memory 12 and flash controller 12A, ROM 13, and static random access memory SRAM 14.

The prior art, such as the assignee's MSC 1210 microsystem chip, does not include the algorithm of the present invention, which provides multiple segmenting of each page erase operation to allow frequent CPU access to flash memory 12 between the segments of a page erase operation. However, the MSC 1210 does include all hardware needed to support execution of the segmented page erase algorithm of the present invention.

FIG. 4 shows a flow chart of an incremental page erase algorithm executed by CPU 11 in accordance with the present invention to segment the flash memory page erase operations to allow faster system response to interrupt service routine requests by CPU 11. The incremental page erase algorithm is stored as program code either in external memory 18 or read-only memory 13 of FIG. 3 and is executed by CPU 111 in accordance with the present invention to incrementally segment the flash memory page erase operations, in order to allow system response to interrupt service routine requests by CPU 11 between any of the segments.

If CPU 11 wants to perform a page erase by executing the page erase command, it sends a page erase request signal to flash memory controller 12A. Flash memory controller 12A starts the page erase operation and digitally pre-defines how long it takes to perform the page erase. The timing for performing a flash memory page erase, flash memory write cycle, and flash memory reads cycle all are programmable. Therefore, the programmable and therefore flexible timing (rather than process-dependent resistors and capacitance values of the prior art) determine how fast the system responds to interrupt service routine requests.

When the CPU is “idling” during a page erase of the flash memory 12, CPU 11 usually is idling at a point determined program code within the ROM. Routines are provided for CPU 11 so it can execute the idling code, and the idling code will perform the required handshaking with flash memory controller 12A, and flash memory controller 12A informs the application program code that the page erase is complete or that it is to be performed with a partial one millisecond incremental page erase interval, and causes a resumption of execution of program application code in flash memory 12.

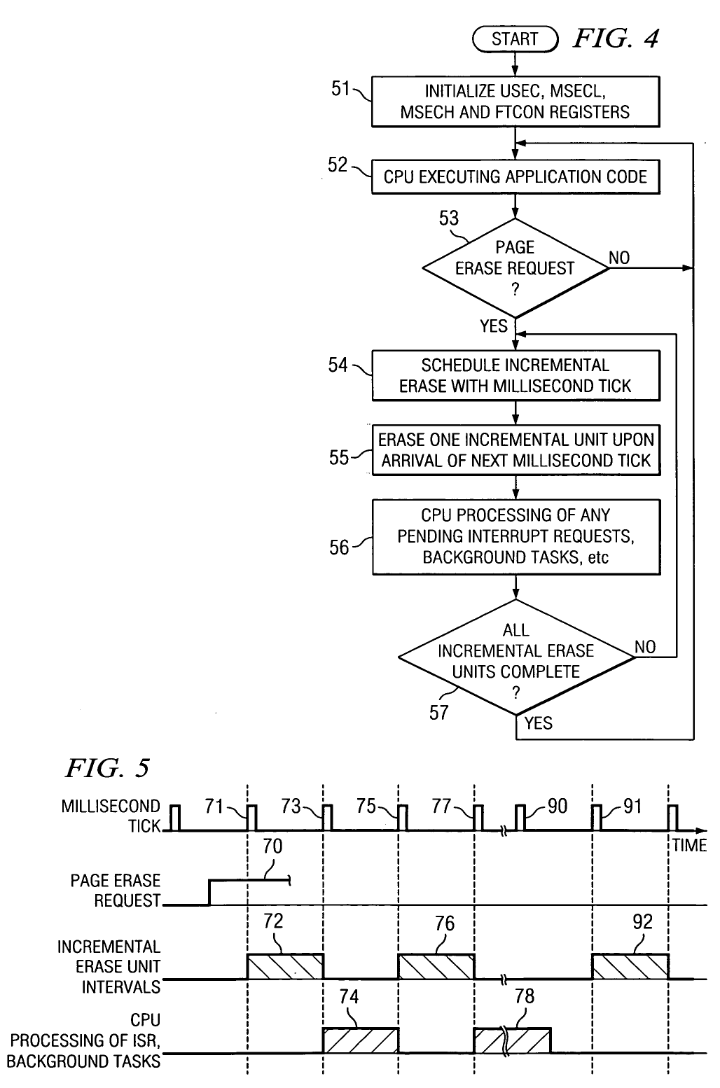

Block 51 of the flow chart in FIG. 4 refers to a number of registers that have been defined in microsystem 10 of FIG. 3. According to the present invention, the flash memory access time segment intervals are programmable, and therefore determined by the CPU. One of the registers is referred to as the “USEC” register, which is used for setting up a “microsecond tick” internal signal that is used to provide the main internal clock for microsystem 10. A register MSECL and a register MSECH are used for setting up low and high levels, respectively, of a “millisecond tick” internal clock signal to enable various timers in microsystem 10 to operate correctly. The millisecond tick clock signal is shown in the timing diagram of FIG. 5. Also, an FTCON register (Flash Timing Control register) is used to set up the amount of time the user wishes to allocate for erasing, reading, and writing flash memory 12. The foregoing registers are hardware registers in the above mentioned MSC 1210 chip.

All of these registers must be initialized according to the value of the clock frequency to be used for the microsystem. (For example, for an 8 MHz system the register values have to be initialized to different values than for a higher system clock frequency, for example 22 MHz.) The initialization values put into the registers establish values of internal clock signals, including the microsecond tick signal and the millisecond tick signal shown in FIG. 5. Using the internal microsecond tick signal and the internal millisecond tick signal, the FTCON register is initialized to determine how much time is established for each segment of the flash memory page erase operation, the flash memory write operation, and the flash memory read operation. (The minimum required write time of flash memory 12 is approximately 30-40 microseconds. For other prior art flash memory processes that use RC time constants, the semiconductor manufacturing process variations are so large that it would cause the write times to be out of specification. Although the basic storage function of flash memory cells is very forgiving of such variations, if the write times are out of specification as a result of process parameter variations, this may reduce the quality of the flash memory even though it remains functional. For example, if the write time is too long, it “over-cooks” the flash memory cell gate oxide 7. Therefore, it is necessary that the flash memory write specification time be met. This is accomplished by using the above-mentioned programming of the values of the registers referred to in block 51 of FIG. 4. The flash memory read time should be a short as possible so that the sense amplifiers (not shown) of the flash memory cell array can be turned off as soon as possible in order to reduce power dissipation therein. Because of the required high gain of the sense amplifiers, they dissipate a large amount of power. As an example, for a relatively low CPU instruction execution rate of 1 MHz, the flash memory cell read time is 2 microseconds, so the sense amplifiers are on during the 2 microsecond flash memory read time, which is not acceptable for very low power applications. However, in accordance with present invention the flash memory read time is pre-programmed to a minimum access time off as little as 30 nanoseconds, which is far less than 2 microseconds, thereby greatly reducing power consumption in the sense amplifiers.)

Referring to block 52, after all of the above-mentioned registers are initialized, CPU 11 starts executing program code, which includes main application code, interrupt service routine code, and background task code. The application code attempts to handle all interrupt service routine requests when they occur. CPU 11 begins to execute the user application program code after the above-mentioned registers are initialized in block 51

Next, the incremental page erase program goes to block 53 during the course of execution of the application code in block 52 to determine if a page erase is being requested by the application code being executed. (In some cases, a page erase might be requested by a device which interrupts CPU 11, rather than the application code referred to in block 52.) An example of a situation that might give rise to the need for a page erase during execution of an application program is that the application program might be repetitively performing an averaging computation, storing the results in flash memory 12, and then needing to free up part of the flash memory to allow storage of new computed averaging results in the same memory space.

If the determination of decision of block 53 is that a page erase is required, the incremental page erase program goes to block 54, but otherwise the program returns to block 52 and CPU 11 continues to execute the application program. In block 54 the program “schedules” an incremental page erase, i.e., breaks the total page erase time up into small increments or sections, which are referred to herein as “incremental erase intervals”. For example, the total page erase time is broken up into eleven 1-millisecond sections according to a “millisecond tick” clock signal, as shown in FIG. 5.

Referring now to both FIG. 4 and FIG. 5, the “MILLISECOND TICK” waveform is an internal clock signal which provides a narrow pulse every millisecond. That clock signal is generated in accordance with the values established during the initialization performed in block 51. The next waveform is the “PAGE ERASE REQUEST” signal which initially is at a low level, and then goes to a high level 70 as shown if a page erase operation is requested by the user application program. That causes a first incremental erase interval 72 shown in FIG. 5 to begin in response to the rising edge 71 of the next millisecond tick pulse. During the incremental erase interval, the program performs one “incremental unit” of erasure of the entire page to be erased upon arrival of the next millisecond tick pulse, as indicated in block 55 of FIG. 4.

The first incremental erase interval 72 stops exactly 1 millisecond later in response to the rising edge 73 of the next millisecond tick pulse, as shown. Immediately after the first incremental erase interval 72, CPU 11 processes any pending interrupt requests, background tasks, etc., as indicated in block 56. That is, CPU 11 again obtains full access to memory bus 19 and flash memory 12 immediately after the end of first incremental erase interval 72 as indicated by interval 74 in FIG. 5 and starts handling any pending interrupt service routine requests that may have occurred during the first incremental erase interval 72. This is indicated in block 56 of FIG. 4.

The incremental page erase program being executed by CPU 11 then determines if all of the incremental page erase operations required for the present page erase have been completed, as indicated in decision block 57. If not, the incremental page erase program being executed by CPU 11 re-enters block 54 and repeats the above described process. If all incremental page erase operations have been completed, the incremental page erase program returns to block 52.

Referring to FIG. 5, the time required to respond to interrupt service routine requests may anywhere from very short to very long. The shaded area interval 74 in FIG. 5 can represent the servicing by CPU 11 of an interrupt service routine which is completed before the occurrence of the next 1 millisecond tick pulse 75. In this case, the next incremental page erase operation 76 is scheduled to start at the time of the leading edge 75 of the next 1 millisecond tick pulse. After incremental page erase operation 76 is complete, CPU 11 is again free to access flash memory 12 to respond to the next interrupt service routine request or perform a background task, as indicated by shaded area 78. The CPU execution of the next interrupt service routine request or background task is indicated by shaded area 78 in FIG. 5, and may be much longer in duration than 1 millisecond. After the second interrupt service routine or background task is completed, the incremental page erase program waits for the next 1 millisecond tick 91 to begin the next incremental page erase interval 92, and so forth. (This procedure is what occurs in blocks 54, 55 and 56 of FIG. 4.) The way in which the erasing of flash memory cells referred to in block 55 is accomplished is described previously herein. (It should be understood, however, that the present invention is not restricted to using 1 millisecond intervals between tick pulses as the incremental erase unit intervals. For example, a “standard” total flash memory page erase time of 11 milliseconds can be segmented into 10 or 11 incremental erase unit intervals of one millisecond each, five incremental erase unit intervals of two milliseconds each, four incremental erase unit intervals of three milliseconds each, three incremental erase unit intervals of four millisecond each, or five incremental erase unit intervals of two milliseconds each, depending on how many times it is desired for the CPU to be able to service pending interrupt service requests during a complete flash memory page erase operation. Thus, the actual total flash memory erase time may be somewhat less than, equal to, or somewhat greater than the standard 11 millisecond total flash memory page erase time.)

Referring again to FIG. 4, after performing the incremental page erase operation of block 55, CPU 11 then processes pending interrupt service routines, background tasks etc., and performs one incremental page erase interval upon arrival of the next 1 millisecond tick pulse, as indicated in block 56. As indicated in block 57, this operation is repeated until all 11 incremental page erase intervals have been completed. At this point, the total page erase operation has been completed, and the incremental page erase program then returns to block 52 and CPU 11 continues executing the application program code.

The timing in FIG. 5 shows that CPU 11 can always return to executing the present application program code, including any pending interrupt service routine requests, within one millisecond, rather than having to wait as much as 11 milliseconds. That is, the wait time imposed by a flash memory page erase operation for the described embodiment of invention is never more than one incremental page erase interval, i.e., 1 millisecond.

Thus, the present invention segments the total erase time into a number of partial or incremental erase intervals. Each incremental page erase interval is a small part of one total page erase time. After each page erase operation, CPU 11 can resume operation to execute pending interrupt service routine requests or background tasks.

The duration of each incremental erase time is programmable in the described embodiment of invention, whereby the appropriate time values are established during the initialization procedure of block 51 of FIG. 4. Adding all of the incremental page erase intervals of a particular page erase operation may result in a total page erase time that is slightly longer than the duration of a single total page erase time achieved in a conventional un-segmented page 4 or 11 millisecond interval erase operation. If microsystem 10 provides 1-millisecond tick intervals, the actual amount of time during which the above-mentioned FT tunneling mechanism operates to erase individual flash memory cells to accomplish incremental erasing thereof actually is less than 1 millisecond, due to inherent internal circuit delays. Therefore, in some cases an 11th incremental page erase interval may be added to the first 10 incremental page erase intervals in order to ensure at least a total 10 millisecond actual erase operation on each flash memory cell. This may be important because discharging of the floating gate 6 through the gate oxide 7 so as to reliably erase a stored “1” state requires a certain mathematical product of the erase current in channel region 9 and the erase time during which the FT tunneling mechanism occurs, and segmenting of the specified total page erase time for the flash memory cells into many segments results in slightly less effective erasing of the flash memory cells than if the total erase time is un-segmented as in the prior art.

In accordance with the present invention, the above described incremental page erase technique avoids long wait times for servicing interrupt requests by segmenting the total page erase time, and accomplishes this without greatly reducing the flash memory retention parameter. This is thought to be a surprising results, because an excessive number of erase cycles is well known to cause a reliability problem with gate oxide 7 of a flash memory cell 1 as shown in FIG. 1. The reliability of a flash memory cell relates to its endurance and its retention. However, the above described segmenting of the page erase operation multiplies the number of erase cycles by the number of segments, and therefore would be expected to substantially reduce the endurance and hence the reliability of a flash memory. However, the assignee's experiments show that the needed value of flash memory retention is achieved in the present invention.

It should be understood that the parameters of most prior flash memory manufacturing processes (including the assignee's present flash memory processes) do not provide a sufficient combination of flash memory retention and endurance to allow practical implementation of a multiply-segmented flash memory page erase operation into a large number of segments, because the endurance times of all flash memory manufacturing processes except the above-mentioned TSMC proprietary flash memory core system are far too short to allow practical segmenting of the flash memory page erase operation into multiple short segments between which the CPU could execute interrupt service routine requests. This is because multiplying of the number of page erase cycles to which the gate oxide of each flash memory cell is subjected by the number of segments per page erase operation would greatly shorten the life of the flash memory cells, because the gate oxides of the flash memory cells would be permanently weakened under the stress of a greatly increased number of page erase cycles. Therefore, it is believed that nothing in the prior art would have suggested that implementing the flash memory page erase segmenting technique of the present invention would have provided a potential benefit that would have been worth the reduction of the endurance and retention parameters of the flash memory that normally would have been expected.

In accordance with present invention, it has been discovered that for the above-mentioned TSMC embedded flash memory systems, the product endurance specification over a suitable temperature range is large enough to provide an adequate “net” endurance specification for the microsystem shown in FIG. 3 even though the number of erase cycles to which each flash memory cell is subjected to may be increased by a factor of 10 or 11 over the prior art, whereas it was not previously recognized that this would be practical. Only after substantial experimentation was it realized that it could be practical to segment the total page erase time into as many as 10 or more incremental page erase intervals and nevertheless achieve acceptable flash memory retention and endurance parameters.

The above described system provides much faster system responses than a system including a conventional single partition flash memory. The above described system also provides somewhat faster system responses than prior systems including double partition flash memories while nevertheless utilizing a much simpler hardware design with less software overhead and less complex circuitry than the prior systems which include two flash memory partitions.

The present invention does not result in unacceptably reduced flash memory retention and endurance parameter specifications. The assignee's experiments have shown that after all of the incremental erase units have been performed, the above described incremental page erase process does not result in a substantial reduction in the achieved in value of the flash memory retention parameter compared to the value achieved using a conventional non-segmented page erase operation. Thus, the present invention provides greatly improved overall system performance by eliminating the previously required long wait times for executing interrupt service routines without any substantial loss of flash memory retention.

While the invention has been described with reference to several particular embodiments thereof, those skilled in the art will be able to make various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention. For example, it would be possible to achieve the described incremental page erase operation using more software and less hardware than in the above described embodiments of the invention. The above mentioned FTCON register and other above-mentioned hardware registers could be implemented in software.

What is claimed is:

1. A system comprising:
(a) a CPU for executing a user application program;
(b) a flash memory including an array of flash memory cells;
(c) a flash memory controller coupled to the flash memory and also coupled by a memory bus to the CPU; and
(d) an incremental page erase circuit coupled to the CPU and operative in response to a page erase signal to erase a page of the flash memory by causing the CPU to
i. generate a first incremental page erase interval of substantially shorter duration than a total erase time required to erase the flash memory,
ii. cause the memory controller to take control of the memory bus and apply erase signals to all flash memory cells of the page during the first incremental page erase interval,
iii. cause the CPU to take control of the memory bus after the first incremental page erase interval and execute a pending task, and
iv. repeat steps (i) through (iii) for a plurality of additional incremental page erase intervals, respectively, the cumulative amount of erase time of all of the incremental page erase intervals being sufficient to result in erasure of the page with at least a predetermined retention time.

2. The system of claim 1 wherein the incremental page erase circuit is included in a read only memory coupled to the memory bus.

3. The system of claim 1 wherein the read only memory is external to an integrated microsystem including a memory system and the CPU.

4. The system of claim 2 wherein the read only memory is internal to an integrated microsystem including a memory system and the CPU.

5. The system of claim 1 wherein the cumulative amount of time of all of the incremental page erase intervals slightly exceeds a specified time interval for accomplishing a complete page erase operation on the flash memory.

6. The system of claim 1 wherein the incremental page erase time intervals are of equal duration.

7. The system of claim 6 wherein the CPU initializes a register by writing into it a value which determines the duration of the incremental page erase intervals.

8. The system of claim 7 wherein the value determines the duration of the incremental page erase intervals to be one millisecond.

9. The system of claim 1 wherein the incremental page erase circuit is internal to an integrated microsystem including a plurality of peripheral devices.

10. The system of claim 9 wherein the plurality of peripheral devices includes a delta sigma analog-to-digital-converter.

11. The system of claim 1 wherein the pending task includes an interrupt service routine request.

12. The system of claim 1 wherein the pending task includes a background task.

13. A method of erasing a page in a system including a CPU, a flash memory including an array of flash memory cells, a flash memory controller coupled to the flash memory and also coupled by a memory bus to the CPU, the method comprising:
operating the CPU in response to a page erase signal produced during execution by the CPU of a user application program to erase a page of the flash memory by causing the CPU to perform the steps of
(a) generating a first incremental page erase interval of substantially shorter duration than a total erase time required to erase the flash memory;
(b) causing the memory controller to take control of the memory bus and apply erase signals to all flash memory cells of the page during the first incremental page erase interval;
(c) causing the CPU to take control of the memory bus after the first incremental page erase interval and execute a pending interrupt service routine request and/or background task; and
(d) performing steps (a) through (c) for a plurality of additional incremental page erase intervals, respectively, the cumulative amount of erase time of all of the incremental page erase intervals being sufficient to result in erasure of the page with at least a predetermined retention time.

14. The method of claim 13 including storing an incremental page erase interval program in a memory coupled to the memory bus and operating the CPU to execute the incremental page erase interval program to perform steps (a)-(d).

15. The method of claim 13 wherein the cumulative amount of time of all of the incremental page erase intervals slightly exceeds a specified time interval for accomplishing a complete page erase operation on the flash memory.

16. The method of claim 13 wherein the incremental page erase intervals are of equal duration.

17. The method of claim 16 wherein the CPU initializes a register by writing into it a value which determines the duration of the incremental page erase intervals.

18. A system comprising:
(a) a CPU;
(b) a flash memory including an array of flash memory cells;
(c) a flash memory controller coupled to the flash memory and also coupled by a memory bus to the CPU,
(d) means for operating the CPU in response to a page erase signal produced during execution by the CPU of a user application program to erase a page of the flash memory by
i. generating a first incremental page erase interval of substantially shorter duration than a total erase time required to erase the flash memory,
ii. causing the memory controller to take control of the memory bus and apply erase signals to all flash memory cells of the page during the first incremental page erase interval,
iii. causing the CPU to take control of the memory bus after the first incremental page erase interval and execute a pending interrupt service routine request and/or a background task, and
iv. repeating steps (i) through (iii) for a plurality of additional incremental page erase intervals, respectively, the cumulative amount of erase time of all of the incremental page erase intervals being sufficient to result in erasure of the page with a predetermined retention time.

19. The system of claim 18 including means for storing an incremental page erase interval program in a memory coupled to the memory bus and means for operating the CPU to execute the incremental erase interval program to perform steps (i) through (iii).

20. The system of claim 18 wherein the cumulative amount of time of all of the incremental page erase intervals slightly exceeds a specified time interval for accomplishing a complete page erase operation on the flash memory.

21. The flash memory system of claim 18 wherein the incremental page erase intervals are of equal duration.

22. The flash memory system of claim 21 wherein the CPU initializes a register by writing a value which determines the duration of the incremental page erase intervals.
